(19) United States
(12) Patent Application Publication
(10) Pub. No.: US 2014/0038054 A1
(43) Pub. Date: Feb. 6, 2014

(54) ALL-SOLID-STATE BATTERY AND PRODUCTION METHOD THEREOF

(71) Applicants: Takeshi TOJIGAMORI, Susono-shi (JP); Chihiro YADA, Brussels (BE); Masato HOZUMI, Susono-shi (JP)

(72) Inventors: Takeshi TOJIGAMORI, Susono-shi (JP); Chihiro YADA, Brussels (BE); Masato HOZUMI, Susono-shi (JP)

(73) Assignee: TOYOTA JIDOSHA KABUSHIKI KAISHA, Toyota-shi (JP)

(21) Appl. No.: 13/947,374

(22) Filed: Jul. 22, 2013

(30) Foreign Application Priority Data
Jul. 31, 2012 (JP) 2012-170250

(51) Int. Cl. H01M 10/05; H01M 10/058

(52) U.S. Cl. CPC H01M 10/05; H01M 10/058
USPC 429/223; 429/231.5; 29/623.1

(57) ABSTRACT

An all-solid-state battery has a mixed electrode layer in which a positive electrode active material and a negative electrode active material are present in a dispersed state. A solid electrolyte section that contains at least one element that makes up the positive electrode active material and at least one element that makes up the negative electrode active material is formed at an interface between the positive electrode active material and the negative electrode active material. The solid electrolyte section is not formed at interfaces between the positive electrode active material portions and at interfaces between the negative electrode active material portions. The positive electrode active material and the negative electrode active material are in the form of predetermined combinations.

### INCORPORATION BY REFERENCE

The disclosure of Japanese Patent Application No. 2012-170250 filed on Jul. 31, 2012 including the specification, drawings and abstract is incorporated herein by reference in its entirety.

### BACKGROUND OF THE INVENTION

1. Field of the Invention

The invention relates to an all-solid-state battery having high energy density, and to a method for producing an all-solid-state battery.

2. Description of Related Art

The rapid diffusion of information-related devices and communication devices such as personal computers, video cameras and cell phones in recent years has been accompanied by efforts directed at developing batteries to be used as power sources in the foregoing devices. Also, high-output and high-capacity batteries for electric automobiles and hybrid automobiles are the subject of ongoing research in the automotive and other industries. At present, lithium batteries are predominant among various battery types, in terms of their high energy density.

Current commercially available lithium batteries utilize electrolyte solutions that contain combustible organic solvents. As a result, safety devices that suppress rises in temperature during short-circuits must be fitted to the battery, and also improvements in structure and materials are called for in order to prevent short-circuits. Lithium batteries, which are all-solid-state batteries where an electrolyte solution is replaced by an electrolyte layer, utilize by contrast no combustible organic solvent inside the battery, and arguably make for simpler safety devices, while being superior in terms of manufacturing costs and productivity.

As a method for producing an all-solid-state battery, for instance, Japanese Patent Application Publication No. 2012-069248 (JP-2012-069248 A) discloses a method for producing an all-solid-state battery, the method having: a step of layering a solid electrolyte on a positive electrode mix made up of a positive electrode active material and a solid electrolyte, followed by pressure molding, to yield a positive electrode member; a step of layering a solid electrolyte on a negative electrode mix made up of a negative electrode active material and a solid electrolyte, followed by pressure-molding, to yield a negative electrode member; and a step of pressure-molding the positive electrode member and the negative electrode member obtained in the foregoing steps, with bonding of the respective solid electrolytes to each other.

### SUMMARY OF THE INVENTION

Higher energy densities are required in terms of improving the performance of all-solid-state batteries. It is thus an object of the invention to provide an all-solid-state battery having high energy density.

A first aspect of the invention relates to an all-solid-state battery that has a mixed electrode layer in which a positive electrode active material and a negative electrode active material are present in a dispersed state. A solid electrolyte section that contains at least one element that makes up the positive electrode active material and at least one element that makes up the negative electrode active material is formed at an interface between the positive electrode active material and the negative electrode active material. The solid electrolyte section is not formed at interfaces between the positive electrode active material portions and at interfaces between the negative electrode active material portions. The positive electrode active material is a spinel-structure oxide that has Li, Ni and Mn, and the negative electrode active material is an alloy that contains Al and Mg.

In the above configuration, the solid electrolyte section is selectively formed at required portions, and hence the proportion of active materials can be relatively increased, and an all-solid-state battery can be obtained that has high energy density. Moreover, the all-solid-state battery has a mixed electrode layer, and hence is particularly advantageous in terms of increasing energy density. A spinel-structure oxide that has Li, Ni and Mn may be used as the positive electrode active material. This active material affords high potential, and hence an all-solid-state battery can be achieved that delivers substantial electromotive force (battery voltage).

A second aspect of the invention relates to an all-solid-state battery that has a mixed electrode layer in which a positive electrode active material and a negative electrode active material are present in a dispersed state, wherein a solid electrolyte section that contains at least one element that makes up the positive electrode active material and at least one element that makes up the negative electrode active material is formed at an interface between the positive electrode active material and the negative electrode active material. The solid electrolyte section is not formed at interfaces between the positive electrode active material portions and at interfaces between the negative electrode active material portions. The positive electrode active material is a layered rock-salt oxide that has Li and Co, and the negative electrode active material is a Nb oxide.

In the above configuration, the solid electrolyte section is selectively formed at required portions, and hence the proportion of active materials can be relatively increased, and an all-solid-state battery can be obtained that has high energy density. The all-solid-state battery of the invention may have a mixed electrode layer, and is particularly advantageous in terms of increasing energy density. Also, a layered rock-salt oxide that has Li and Co is used as the positive electrode active material, and a Nb oxide is used as the negative electrode active material. These active materials have high electron conductivity, and hence an all-solid-state battery can be achieved that is suitable for high output.

A third aspect of the invention is a method for producing an all-solid-state battery, wherein the method involves preparing an electrode member in which a positive electrode active material and a negative electrode active material are in contact with each other; and performing a thermal treatment en the electrode member and forming a solid electrolyte section that contains at least one element that makes up the positive electrode active material and at least one element that makes up the negative electrode active material, at an interface between the positive electrode active material and the negative electrode active material. The positive electrode active material is a spinel-structure oxide that has Li, Ni and Mn, and the negative electrode active material is an alloy that contains Al and Mg.

In the above method, the solid electrolyte section can be selectively formed at required portions, and hence the proportion of active materials can be relatively increased, and an all-solid-state battery can be obtained that has high energy density.

A fourth aspect of the invention is a method for producing an all-solid-state battery, wherein the method involves preparing an electrode member in which a positive electrode active material and a negative electrode active material are in contact with each other; and performing a thermal treatment on the electrode member and forming a solid electrolyte section that contains at least one element that makes up the positive electrode active material and at least one element that makes up the negative electrode active material, at an interface between the positive electrode active material and the negative electrode active material. The positive electrode active material is a layered rock-salt oxide that has Li and Co, and the negative electrode active material is a Nb oxide.

In the above method, the solid electrolyte section can be selectively formed at required portions, and hence the proportion of active materials can be relatively increased, and an all-solid-state battery can be obtained that has high energy density.

In the above method, the electrode member may be a mixed electrode layer in which the positive electrode active material and the negative electrode active material are present in a dispersed state. Higher energy density can thus be achieved.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic cross-sectional diagram illustrating an example of an all-solid-state battery of the invention;

FIG. 2A is a schematic cross-sectional diagram for explaining the effect of the invention;

FIG. 2B is a schematic cross-sectional diagram for explaining the effect of the invention;

FIG. 3 is a schematic cross-sectional diagram for explaining an all-solid-state battery of the invention;

FIG. 4A is a schematic cross-sectional diagram illustrating an example of a method for producing an all-solid-state battery of the invention;

FIG. 4B is a schematic cross-sectional diagram illustrating an example of a method for producing an all-solid-state battery of the invention;

FIG. 5A is a schematic cross-sectional diagram illustrating an electrode member of the invention;

FIG. 5B is a schematic cross-sectional diagram illustrating an electrode member of the invention;

FIG. 5C is a schematic cross-sectional diagram illustrating an electrode member of the invention;

FIG. 6 is a production flow of a mixed electrode layer in Example 1-1;

FIG. 7A illustrates X-ray diffraction (XRD) measurement results for mixed electrode layers obtained in Examples 1-1 and 1-2 and Comparative examples 1-1 to 1-3;

FIG. 7B is a diagram, being a partial enlargement of FIG. 7A, illustrating XRD measurement results for mixed electrode layers obtained in Examples 1-1 and 1-2 and Comparative examples 1-1 to 1-3;

FIG. 8 illustrates XRD measurement results for a mixed electrode layer obtained in Comparative example 1-4;

FIG. 9 illustrates results of transmission electron microscope (TEM) observation for a mixed electrode layer obtained in Example 1-1;

FIG. 10 illustrates results of thermogravimetric-differential thermal analysis (TG-DTA) for LiNi_{0.5}Mn_{1.5}O₄ that is used in Example 1-1;

FIG. 11 is a production flow of a mixed electrode layer in Example 2-1; and

FIG. 12 illustrates XRD measurement results for mixed electrode layers obtained in Examples 2-1 to 2-7 and Comparative examples 2-1 and 2-2.

### DETAILED DESCRIPTION OF EMBODIMENTS

The all-solid-state battery and the production method thereof of the invention are explained in detail below.

A. All-Solid-State Battery

The all-solid-state battery of the invention can be broadly divided into two embodiments. The explanation of the all-solid-state battery of the invention will be divided into a first embodiment and a second embodiment.

1. The all-solid-state battery of the first embodiment has a mixed electrode layer in which a positive electrode active material and a negative electrode active material are present in a dispersed state. A solid electrolyte section that contains at least one element that makes up the positive electrode active material and at least one element that makes up the negative electrode active material is formed at an interface between the positive electrode active material and the negative electrode active material. The solid electrolyte section is not formed at interfaces between the positive electrode active material portions or at interfaces between the negative electrode active material portions. The positive electrode active material is a spinel-structure oxide that has Li, Ni and Mn, and the negative electrode active material is an alloy that contains Al and Mg.

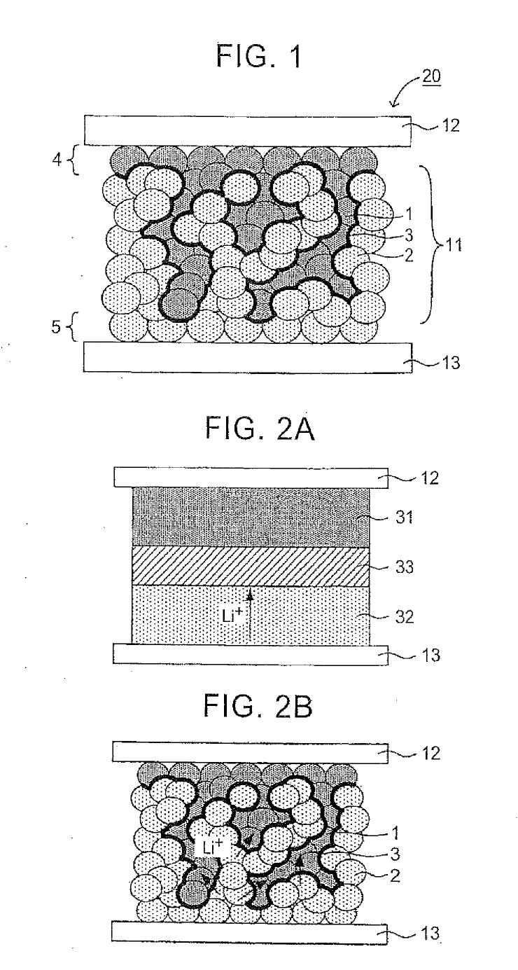

FIG. 1 is a schematic cross-sectional diagram illustrating an example of the all-solid-state battery of the first embodiment. An all-solid-state battery 20 in FIG. 1 has a mixed electrode layer 11 in which a positive electrode active material 1 and a negative electrode active material 2 are present in a dispersed state. A solid electrolyte section 3 is formed at the interface between the positive electrode active material 1 and the negative electrode active material 2. The solid electrolyte section 3 contains at least one element that makes up the positive electrode active material 1, and at least one element that makes up the negative electrode active material 2. The solid electrolyte section 3 is not formed at interfaces between positive electrode active material portions 1 or at interfaces between negative electrode active material portions 2, but is selectively formed at the interface between the positive electrode active material 1 and the negative electrode active material 2. A short-preventing layer 4 made up of the positive electrode active material 1 is formed on one of the surfaces of the mixed electrode layer 11, and a short-preventing layer 5 made up of the negative electrode active material 2 is formed on the other surface of the mixed electrode layer 11. A positive electrode collector 12 is disposed so as to be in contact with the short-preventing layer 4, and a negative electrode collector 13 is disposed so as to be in contact with the short-preventing layer 5.

In the first embodiment, the solid electrolyte section is selectively formed at required portions, and hence the proportion of active materials can be relatively increased, and an all-solid-state battery can be obtained that has high energy density. The all-solid-state battery of the first embodiment has a mixed electrode layer, and hence is particularly advantageous in terms of increasing energy density. This effect will be explained with reference to FIG. 2A and FIG. 2B.

Conventional stacked all-solid-state batteries have a basic structure in which a positive electrode layer 31, a solid electrolyte layer 33 and a negative electrode layer 32 are stacked in this order, as illustrated in FIG. 2A. In the negative electrode layer 32, for instance, the Li ion diffusion distance is long upon migration of Li ions from the vicinity of the negative electrode collector 13 to the solid electrolyte layer 33. In liquid-system batteries, an electrolyte solution permeates the electrode layer, and thus sufficient ion conduction paths are present. Therefore, a somewhat long Li ion diffusion distance does not pose a significant problem. An all-solid-state battery, by contrast, utilizes a solid electrolyte material, and does not enjoy therefore a permeation effect such as that of the electrolyte solution; also, the active material itself has ordinarily low Li ion conductivity. In consequence, ion conduction paths in the electrode layer are insufficient, and the solid electrolyte material must be present in order to increase ion conductivity in the electrode layer. As a result, the proportion of active material decreases relatively, and a sufficient increase in energy density cannot be achieved. In the mixed electrode layer, by contrast, the positive electrode active material 1 and the negative electrode active. material 2 are present in a dispersed state, as illustrated in FIG. 2B. Therefore, the Li ion diffusion distance is short even for those Li ions that are present in the vicinity of the negative electrode collector 13. Since the Li ion diffusion distance is shorter, the solid electrolyte material need no longer be used, and higher energy density can thus be achieved by virtue of the accordingly greater proportion of active material.

In all-solid-state batteries having so-called thin-film electrode layers, the Li ion diffusion distance in the electrode layers is short, but the battery cannot be made thicker (that is, the proportion of active material with respect to the battery as a whole cannot be increased), and it is not possible to achieve a sufficient increase in energy density. By contrast, the Li ion diffusion distance in a mixed electrode layer can be kept short even if the latter is made thicker, and hence it becomes possible to achieve higher energy density.

In the mixed electrode layer, the positive electrode active material and the negative electrode active material are in an intricately dispersed state, and hence the opposing surface area of the positive electrode active material and the negative electrode active material (surface area of contact via the solid electrolyte section) is larger. Accordingly, an all-solid-state battery can be achieved that is suitable for high output. A spinel-structure oxide that has Li, Ni and Mn is used as the positive electrode active material in the first embodiment. This active material affords high potential, and hence an all-solid-state battery can be achieved that delivers substantial electromotive force (battery voltage). As illustrated in FIG. 1, the mixed electrode layer 11 has the solid electrolyte section 3 at the interface between the dispersed positive electrode active material 1 and negative electrode active material 2. Forming selectively a solid electrolyte section at interfaces having such complex shapes was conventionally difficult. By contrast, a solid electrolyte section can be selectively formed at an interface having a complex shape by, for instance, forming the solid electrolyte section in a self-formation fashion through reaction of the positive electrode active material and the negative electrode active material, as described below. The features of the all-solid-state battery of the first embodiment are explained next.

(1) The mixed electrode layer of the first embodiment is a layer in which the positive electrode active material and the negative electrode active material are present in a dispersed state. Herein, “dispersed state” denotes a state in which positive electrode active material portions and negative electrode active material portions are tangled with each other. Preferably, the mixed electrode layer is a layer obtained, for instance, by mixing the positive electrode active material and the negative electrode active material. A predetermined solid electrolyte section is formed at the interface between the positive electrode active material and the negative electrode active material, such that the solid electrolyte section is not formed at interfaces between positive electrode active material portions or at interfaces between negative electrode active material portions.

(i) The positive electrode active material in the first embodiment is a spinel-structure oxide that has Li, Ni and Mn. Preferably, the positive electrode active material is an active material that is capable of forming a desired solid electrolyte section by reacting with the negative electrode active material described below.

Examples of the positive electrode active material include, for instance, an active material represented by formula LiMn_{2-x-y}NiₓM_{y}O₄ (where 0<x<2, 0≦y<2, and M is at least one from among Co, Fe, Cr, Cu, Ti and Ru). In the formula, x is preferably 0.1 or greater, more preferably 0.4 or greater, since the characteristics of Ni (characteristic of imparting high potential) may be manifested less readily if the value of x is excessively small. Preferably, x is 1 or less, more preferably 0.5 or less, since an unintended crystalline phase may form readily if the value of x is excessively large. In the formula, the value of y varies for instance depending on the type of M, but satisfies preferably, for instance, 0≦y≦0.5. Also, y may satisfy y=0. In the above formula, M is preferably at least one from among Co, Fe, Cr, Ti and Ru. Specific examples of such a positive electrode active material include, for instance, LiNi_{0.5}Mn_{1.5}O₄, LiCr_{0.1}Ni_{0.4}Mn_{1.5}O₄, LiNi_{0.45}Ru_{0.05}Mn_{1.5}O₄ or the like.

The shape of the positive electrode active material is not particularly limited, but is preferably a particulate shape. In this case, the average particle size (D₅₀) of the positive electrode active material ranges for instance from 1 nm to 100 μm, preferably from 10 nm to 30 μm.

(ii) The negative electrode active material in the first embodiment is an alloy that contains Al and Mg. Preferably, the negative electrode active material is an active material that is capable of forming a desired solid electrolyte section by reacting with the above-described positive electrode active material.

Examples of the negative electrode active material include, for instance, an alloy represented by formula AlₓMg_{y}M_{z} (where 0<x<1, 0<y≦0.5, 0≦z<0.5, x+y+z=1, and M is at least one from among Ag, Si, Sn, In, Bi and Sb). In the formula, x is preferably 0.5 or greater, more preferably 0.8 or greater, since high capacity derived from Al may fail to be obtained if the value of x is excessively small. Otherwise, x is not particularly limited, so long as it is smaller than 1. In the formula, y is preferably 0.001 or greater, more preferably 0.01 or greater, since a good solid electrolyte section may fail to be formed if the value of y is excessively small. Preferably, y is 0.4 or smaller, more preferably 0.3 or smaller, since oxidation may be likelier to occur during a thermal treatment if the value of y is excessively large. Preferably, the value of x/(x+y) is for instance 0.5 or greater, more preferably 0.8 or greater. The value of x/(x+y) is ordinarily smaller than 1. In the above formula, the value of z varies for instance depending on the type of M, but satisfies preferably, for instance, 0≦z≦0.3. Also, z may satisfy z=0. In the above formula, M is preferably at least one from among Si, Sn and In. Specific examples of such a negative electrode active material include, for instance, Al_{0.97}Mg_{0.03} or the like.

The shape of the negative electrode active material is not particularly limited, but is preferably a particulate shape. In this case, the average particle size (D₅₀) of the negative electrode active material may range for instance from 1 nm to 100 μm, preferably from 10 nm to 30 μm.

The proportion of the positive electrode active material and the negative electrode active material in the mixed electrode layer is not particularly limited, but, for instance, the negative electrode active material ranges preferably from 0.01 parts by weight to 100 parts by weight, more preferably from 0.05 parts by weight to 50 parts by weight, with respect to 100 parts by weight of the positive electrode active material. That is because sufficient capacity cannot be achieved if the proportion of negative electrode active material is excessively large or excessively small.

(iii) The solid electrolyte section in the first embodiment contains at least one element that makes up the positive electrode active material and at least one element that makes up the negative electrode active material. Preferably, the solid electrolyte section is formed through reaction of the above-described positive electrode active material and negative electrode active material.

The solid electrolyte section is not particularly limited, but preferably contains, for instance, Li, Al, Mg and O. Preferably, Li and O that make up the positive electrode active material and Al and Mg that make up the negative electrode active material react with each other to form thereby a solid electrolyte section that contains the foregoing elements. The crystal structure of the solid electrolyte section is not particularly limited, but, preferably, the solid electrolyte section has for instance a spinel structure. Specifically, the solid electrolyte section has a spinel structure represented by (LiₓMg₁₋₂ₓAlₓ)Al₂O₄. Herein, x satisfies 0<x<0.5.

The average thickness of the solid electrolyte section is not particularly limited, but, for instance, is preferably 10 nm or greater, and ranges preferably from 50 nm to 5 μm. The average thickness of the solid electrolyte section can be determined, for instance, by observation using a scanning electron microscope (SEM) or a TEM.

(iv) The mixed electrode layer in the first embodiment contains at least the positive electrode active material, the negative electrode active material and the solid electrolyte section. The mixed electrode layer may be substantially made up of the positive electrode active material, the negative electrode active material and the solid electrolyte section alone, or may contain other components. Examples of other components include, for instance, conductive materials, solid electrolyte materials and the like.

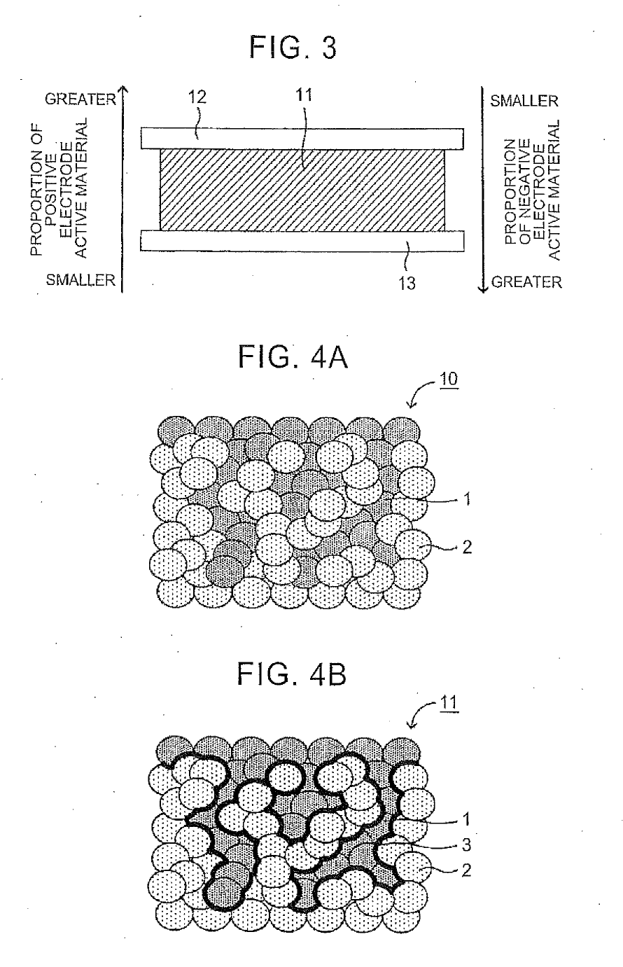

Preferably, the proportion of the positive electrode active material in the mixed electrode layer increases from one of the surfaces to the other surface in the thickness direction. Similarly, the proportion of the negative electrode active material in the mixed electrode layer increases from the other surface to the one surface, in the thickness direction. That is because the proportion of active materials isolated in the mixed electrode layer can be reduced by imparting a gradient to the proportion of the active materials. Preferably, the proportion of the positive electrode active material in the mixed electrode layer 11 increases, in the thickness direction, from one of the surfaces (surface on the negative electrode collector 13 side) towards the other surface (surface on the positive electrode collector 12 side), as illustrated in FIG. 3. Similarly, the proportion of the negative electrode active material in the mixed electrode layer 11 increases preferably, in the thickness direction, from the other surface (surface on the positive electrode collector 12 side) towards the one surface (surface on the negative electrode collector 13 side).

The gradient of the proportion of the active materials may be step-wise or continuous. Examples of a mixed electrode layer in which the proportion of the active materials is graded step-wise include, for instance, a mixed electrode layer made up of a plurality of layers such that at least one proportion from among that of the positive electrode active material and of the negative electrode active material in each layer is adjusted in the thickness direction. Examples of such a mixed electrode layer include, for instance, a mixed electrode layer that is made up of two layers, namely a first layer and a second layer, such that in the first layer, the proportion of the positive electrode active material is greater than the proportion of the negative electrode active material, and in the second layer, the proportion of the negative electrode active material is greater than the proportion of the positive electrode active material. The above proportions can be appropriately selected in accordance with the type of active materials, and may be proportions on a volume basis, a weight basis or a mole basis.

The thickness of the mixed electrode layer is not particularly limited, but, for instance, ranges from 1 μm to 1 cm, and preferably from 10 μm to 1 mm. That is because sufficient capacity may fail to be obtained if the thickness of the mixed electrode layer is excessively small, while electron conductivity in the mixed electrode layer may decrease, and high output may fail to be achieved, if the thickness of the mixed electrode layer is excessively large.

(2) In the first embodiment, preferably, the short-preventing layer is formed on at least one surface of the mixed electrode layer, since occurrence of shorts can be reliably prevented in this case. Examples of the short-preventing layer include, for instance, the short-preventing layer 4 made up of the positive electrode active material 1 and that is formed on one surface of the mixed electrode layer 11, and the short-preventing layer 5 made up of the negative electrode active material 2 and that is formed on the other surface of the mixed electrode layer 11, as illustrated in FIG. 1.

The material of the short-preventing layer is not particularly limited, and may include, for instance, an active material, a solid electrolyte material or the like. The thickness of the short-preventing layer is for instance 0.01 μm or greater, and ranges preferably from 0.1 μm to 100 μm. The method for forming the short-preventing layer is not particularly limited, but may involve, for instance, pressing a material of a first short-preventing layer, pressing thereafter a mix of the mixed electrode layer, and pressing thereafter a material of the second short-preventing layer. For instance, the all-solid-state battery may be produced using a collector having, on the surface, a thin-film short-preventing layer.

(3) The all-solid-state battery of the first embodiment has at least the above-described mixed electrode layer. Ordinarily, the all-solid-state battery further has a positive electrode collector and a negative electrode collector that collect current from the mixed electrode layer. Examples of the materials of the collectors include, for instance, steel use stainless (SUS), aluminum, copper, nickel, iron, titanium, carbon or the like.

(4) The all-solid-state battery of the first embodiment may be a primary battery, or a secondary battery, but is preferably a secondary battery, since a secondary battery can be charged and discharged repeatedly and is useful, for instance, as a battery for automobiles. The shape of the all-solid-state battery of the first embodiment may be, for instance, a coin shape, a laminate shape, a cylindrical shape or a box shape.

2. A second embodiment of the all-solid-state battery of the invention is explained next. The all-solid-state battery of the second embodiment has a mixed electrode layer in which a positive electrode active material and a negative electrode active material are present in a dispersed state, wherein a solid electrolyte section that contains at least one element that makes up the positive electrode active material and at least one element that makes up the negative electrode active material is formed at an interface between the positive electrode active material and the negative electrode active material. The solid electrolyte section is not formed at interfaces between the positive electrode active material portions or at interfaces between the negative electrode active material portions. The positive electrode active material is a layered rock-salt oxide that has Li and Co, and the negative electrode active material is a Nb oxide.

A specific example of the all-solid-state battery of the second embodiment has the same features as those explained with reference to FIG. 1, and hence the features will not be described again.

In the second embodiment, the solid electrolyte section is selectively formed at required portions, and hence the proportion of active materials can be relatively increased, and an all-solid-state battery can be obtained that has high energy density. The all-solid-state battery of the second embodiment has a mixed electrode layer, and hence is particularly advantageous in terms of increasing energy density. In the second embodiment, a layered rock-salt oxide that has Li and Co is used as the positive electrode active material, and a Nb oxide is used as the negative electrode active material. These active materials have high electron conductivity, and, accordingly, an all-solid-state battery can be achieved that is suitable for high output.

(1) The mixed electrode layer in the second embodiment is a layer in which the positive electrode active material and the negative electrode active material are present in a dispersed state. A predetermined solid electrolyte section is formed at the interface between the positive electrode active material and the negative electrode active material. The solid electrolyte section is not formed at interfaces between positive electrode active material portions or at interfaces between negative electrode active material portions.

(i) The positive electrode active material in the second embodiment is a layered rock-salt oxide that has Li and Co. Preferably, the positive electrode active material is an active material that is capable of forming a desired solid electrolyte section by reacting with the negative electrode active material described below.

Examples of the positive electrode active material include, for instance, an active material represented by formula LiCo₁₋ₓMₓO₂ (where 0≦x<1, and M is at least one from among Ni, Mn, Al, Nb and Zr). In the formula, the value of x varies for instance depending on the type of M, but satisfies preferably, for instance, 0≦x≦0.5. Also, x may satisfy x−0. In the above formula, M is preferably at least one from among Ni and Mn. Specific examples of such a positive electrode active material include, for instance, LiCoO₂ or the like. Other features relating to the positive electrode active material are identical to those set forth in the first embodiment described above.

(ii) The negative electrode active material in the second embodiment is a Nb oxide. Preferably, the negative electrode active material is an active material that is capable of forming a desired solid electrolyte section by reacting with the above-described positive electrode active material. Specific examples of the Nb oxide include, for instance, Nb₂O₅, NbO, Nb₁₂O₂₉ or the like. Other features relating to the negative electrode active material are identical to those set forth in the first embodiment described above.

(iii) The solid electrolyte section in the second embodiment contains at least one element that makes up the positive electrode active material and at least one element that makes up the negative electrode active material. Preferably, the solid electrolyte section is formed through reaction of the above-described positive electrode active material and negative electrode active material.

The solid electrolyte section is not particularly limited, but preferably contains, for instance, Li, Nb and O. Preferably, Li that makes up the positive electrode active material and Nb that makes up the negative electrode active material react with each other, and as a result there is formed a solid electrolyte section of an oxide that contains these elements. Examples of the solid electrolyte section include, for instance, LiNbO₃, Li₃NbO₄ or the like, preferably LiNbO₃ among the foregoing, since Li ion conductivity is higher in that case. Other features relating to the solid electrolyte section are identical to those set form in the first embodiment described above.

(2) Other features relating to the all-solid-state battery are identical to those set forth in the first embodiment described above, and an explanation thereof will be omitted.

B. A method for producing an all-solid-state battery of the invention will be explained next. The method for producing an all-solid-state battery of the invention can be broadly divided into two embodiments. The explanation of the method for producing an all-solid-state battery of the invention will be divided into a first embodiment and a second embodiment.

1. A method for producing an all-solid-state battery of the first embodiment has: a preparation step of preparing an electrode member in which a positive electrode active material and a negative electrode active material are in contact with each other; and a thermal treatment step of performing a thermal treatment on the electrode member to form, at the interface between the positive electrode active material and the negative electrode active material, a solid electrolyte section that contains at least one element that makes up the positive electrode active material and at least one element that makes up the negative electrode active material; wherein the positive electrode active material is a spinel-structure oxide that has Li, Ni and Mn, and the negative electrode active material is an alloy that contains Al and Mg.

FIG. 4A and FIG. 4B are schematic cross-sectional diagrams illustrating an example of a method for producing an all-solid-state battery of the first embodiment. In FIG. 4A and FIG. 4B, an electrode member 10 is prepared first in which the positive electrode active material 1 and the negative electrode active material 2 are in contact with each other (FIG. 4A). Next, the electrode member 10 is subjected to a thermal treatment, to form, at the interface between the positive electrode active material 1 and the negative electrode active material 2, the solid electrolyte section 3 that contains at least one element that makes up the positive electrode active material 1 and at least one element that makes up the negative electrode active material 2 (FIG. 4B). The solid electrolyte section 3 is not formed at interfaces between positive electrode active material portions 1 or at interfaces between negative electrode active material portions 2, but is selectively formed at the interface between the positive electrode active material 1 and the negative electrode active material 2.

In the first embodiment, the solid electrolyte section can be selectively formed at required portions, and hence the proportion of active materials can be relatively increased, and an all-solid-state battery can be obtained that has high energy density. In the first embodiment, the solid electrolyte section is formed in a self-formation fashion through reaction of the positive electrode active material and the negative electrode active material. A thin solid electrolyte film can be uniformly formed as a result. Higher energy density can be achieved from this standpoint as well. Through reaction of the positive electrode active material and the negative electrode active material, an interface is formed readily that exhibits high lattice matching between the solid electrolyte section and the active materials, which is advantageous. The steps of the method for producing an all-solid-state battery of the first embodiment are explained below.

(1) The preparation step of the first embodiment is a step of preparing an electrode member in which a positive electrode active material and a negative electrode active material are in contact with each other. The features of the positive electrode active material and the negative electrode active material are identical to those set forth in “A. All-solid-state battery, 1. First embodiment” above.

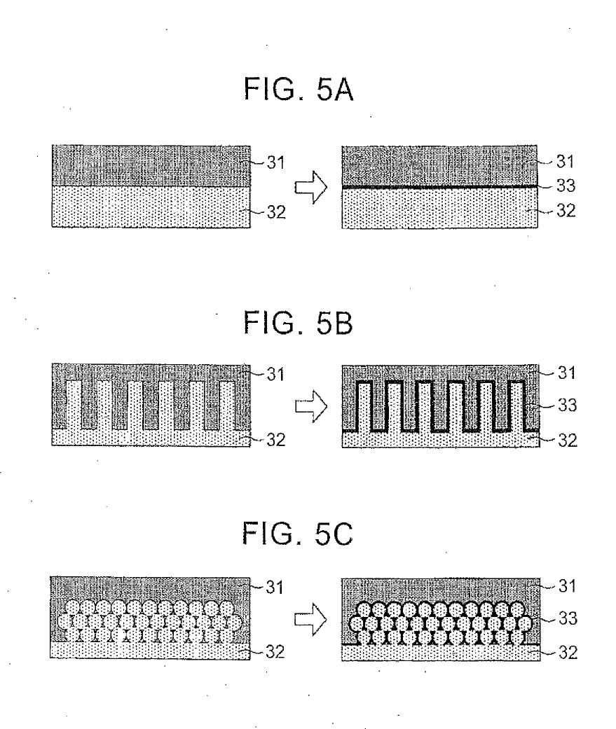

The electrode member is not particularly limited, so long as it is a member in which the positive electrode active material and the negative electrode active material are in contact with each other. An example of the electrode member may be, for instance, the mixed electrode layer in which the positive electrode active material and the negative electrode active material are present in a dispersed state, as illustrated in FIG. 4A. Other examples of the electrode member include, for instance, a member in which a positive electrode layer 31 and a negative electrode layer 32 are stacked in a planar fashion, as illustrated in FIG. 5A, a member in which the positive electrode layer 31 and the negative electrode layer 32 are stacked in a comb-teeth fashion, as illustrated in FIG. 5B, or a member in which the positive electrode layer 31 and the negative electrode layer 32 are in contact with each other in the form of a so-called three dimensionally ordered mesoporous (3DOM) structure, as illustrated in FIG. 5C. In FIG. 5A, FIG. 5B and FIG. 5C, a solid electrolyte layer 33 is formed at the interface between the positive electrode layer 31 and the negative electrode layer 32.

(2) The thermal treatment step of the first embodiment is a step of performing a thermal treatment on the electrode member to form, at the interface between the positive electrode active material and the negative electrode active material, a solid electrolyte section that contains at least one element that makes up the positive electrode active material and at least one element that makes up the negative electrode active material.

The thermal treatment temperature is not particularly limited, so long as the intended solid electrolyte section can be formed, but, for instance, is preferably higher than 600° C., more preferably 650° C. or higher, and yet more preferably 700° C. or higher. For instance, the thermal treatment temperature is preferably lower than 900° C., and is more preferably 850° C. or lower, and yet more preferably 800° C. or lower.

The atmosphere in which the thermal treatment is carried out is not particularly limited, and can be, for instance, an oxygen-containing atmosphere, an inert gas atmosphere or a vacuum atmosphere. Examples of oxygen-containing atmospheres include, for instance, an air atmosphere, a mixed atmosphere of oxygen and an inert gas, and a pure oxygen atmosphere. Examples of inert gases include, for instance, nitrogen gas, argon gas and the like. Preferably, the oxygen concentration is lowered appropriately in cases where a desired solid electrolyte section does not form readily on account of an excessively high oxygen concentration. In a case where, for instance, the active material undergoes reductive decomposition at the temperature at which the solid electrolyte section is generated, it is preferable to carry out firing in an oxygen-containing atmosphere (for instance, air atmosphere) in order to inhibit reductive decomposition reactions. The thermal treatment time ranges preferably, for instance, from 1 minute to 24 hours, more preferably from 10 minutes to 10 hours. Examples of the heating method include, for instance, methods that utilize a firing furnace.

2. A second embodiment of the method for producing an all-solid-state battery of the invention is explained next. The method for producing an all-solid-state battery of the second embodiment has: a preparation step of preparing an electrode member in which a positive electrode active material and a negative electrode active material are in contact with each other; and a thermal treatment step of performing a thermal treatment on the electrode member to form, at the interface between the positive electrode active material and the negative electrode active material, a solid electrolyte section that contains at least one element that makes up the positive electrode active material and at least one element that makes up the negative electrode active material, wherein the positive electrode active material is a layered rock-salt oxide that has Li and Co, and the negative electrode active material is a Nb oxide.

A specific example of the method for producing an all-solid-state battery of the second embodiment has the same features as those explained with reference to FIG. 4A and FIG. 4B, and hence the features will not be described again.

In the second embodiment, the solid electrolyte section can be selectively formed at required portions, and hence the proportion of active materials can be relatively increased, and an all-solid-state battery can be obtained that has high energy density. In the second embodiment, the solid electrolyte section is formed in a self-formation fashion through reaction of the positive electrode active material and the negative electrode active material. A thin solid electrolyte film can be uniformly formed as a result. Higher energy density can be achieved from this standpoint as well. Through reaction of the positive electrode active material and the negative electrode active material, an interface is formed readily that exhibits high lattice matching between the solid electrolyte section and the active materials, which is advantageous. The steps of the method for producing an all-solid-state battery of the second embodiment are explained below.

(1) The preparation step of the second embodiment is a step of preparing an electrode member in which a positive electrode active material and a negative electrode active material are in contact with each other. The features of the positive electrode active material and the negative electrode active material are identical to those set forth in “A. All-solid-state battery, 2. Second embodiment” above. Other features relating to the preparation step are identical to those set forth in the first embodiment described above.

(2) The thermal treatment step of the second embodiment is a step of performing a thermal treatment on the electrode member to form, at the interface between the positive electrode active material and the negative electrode active material, a solid electrolyte section that contains at least one element that makes up the positive electrode active material and at least one element that makes up the negative electrode active material.

The thermal treatment temperature is not particularly limited, so long as the intended solid electrolyte section can be formed, but, for instance, is preferably higher than 400° C., more preferably 450° C. or higher, and yet more preferably 500° C. or higher. For instance, the thermal treatment temperature is preferably lower than 700° C., and is more preferably 650° C. or lower, and yet more preferably 600° C. or lower. Other features relating to the thermal treatment step are identical to those set forth in the first embodiment described above.

The invention is not limited to the above embodiments. The foregoing embodiments are merely illustrative. Thus, the technical scope of the invention encompasses any configuration that has substantially the same features as those of the technical idea according to the invention and set forth in the claims, and that elicits substantially the same effect as that technical idea.

Specific examples of the invention are explained next.

### EXAMPLE 1-1

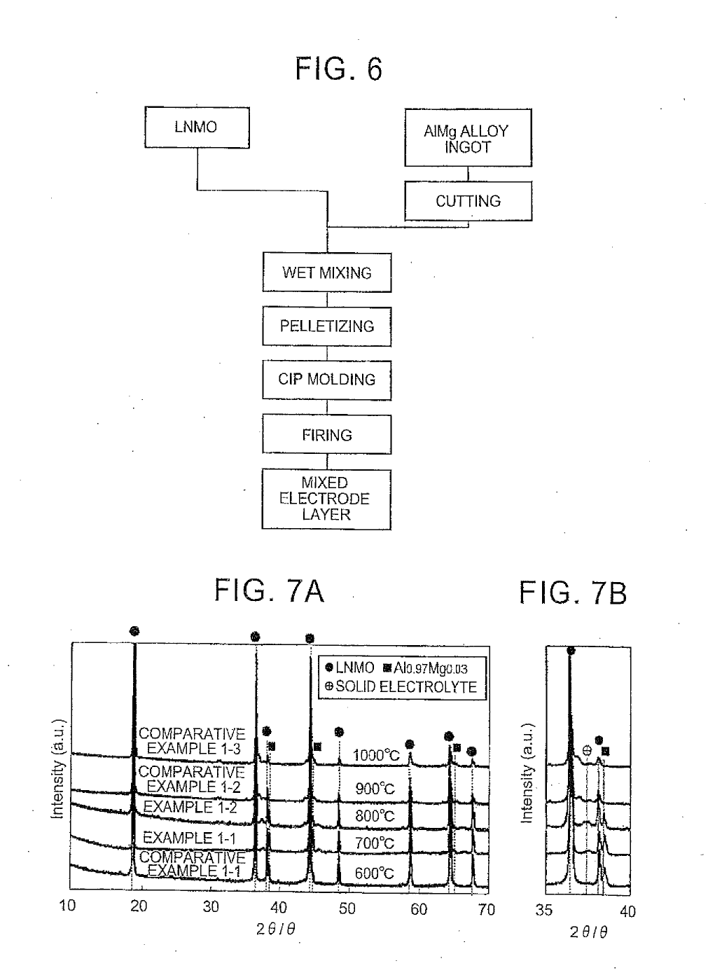

A mixed electrode layer in which a positive electrode active material and a negative electrode active material were present dispersed therein was produced in accordance with the flow illustrated in FIG. 6. Firstly, LiNi_{0.5}Mn_{1.5}O₄ (LNMO, by Nichia Corporation, positive electrode active material) and an AlMg alloy (Al_{0.97}Mg_{0.03}, by Kojundo Chemical Laboratory Co., Ltd., negative electrode active material) obtained through ingot cutting and granulation were weighed to yield a weight ratio of positive electrode active material/negative electrode active material=0.88, and were wet-mixed in a mortar. Ethanol was used as the solvent during mixing. Next, the dried mixture was pressed in a die at a pressure of 20 kN, to yield pellets. The pellets were pressed at 196 MPa using a cold isostatic pressing (CIP) mold. The obtained molded body was heated under conditions of temperature rise rate of 5° C./min, in an air atmosphere. Upon reaching 700° C., the temperature was held there and firing was performed for 8 hours in that state. A mixed electrode layer was obtained as a result.

### EXAMPLE 1-2, COMPARATIVE EXAMPLES 1-1 TO 1-4

Mixed electrode layers were obtained in the same way as in Example 1-1, but herein the firing atmosphere and the firing temperature were modified as given in Table 1.

TABLE 1

| | Positive | Positive | | | |
|---|---|---|---|---|---|
| | electrode/ | electrode/ | | | |
| | negative | negative | | | Firing |
| | electrode | electrode | | Firing | tempera- |
| | weight | molar | Alloy | atmos- | ture |
| | ratio | ratio | composition | phere | (° C.) |
| Example 1-1 | 0.88 | 1.00 | Al_{0.97}Mg_{0.03} | Air | 700 |
| Example 1-2 | | | | Air | 800 |
| Comparative | | | | Air | 600 |
| example 1-1 | | | | | |
| Comparative | | | | Air | 900 |
| example 1-2 | | | | | |
| Comparative | | | | Air | 1000 |
| example 1-3 | | | | | |
| Comparative | | | | Vacuum | 600 |
| example 1-4 | | | | | |

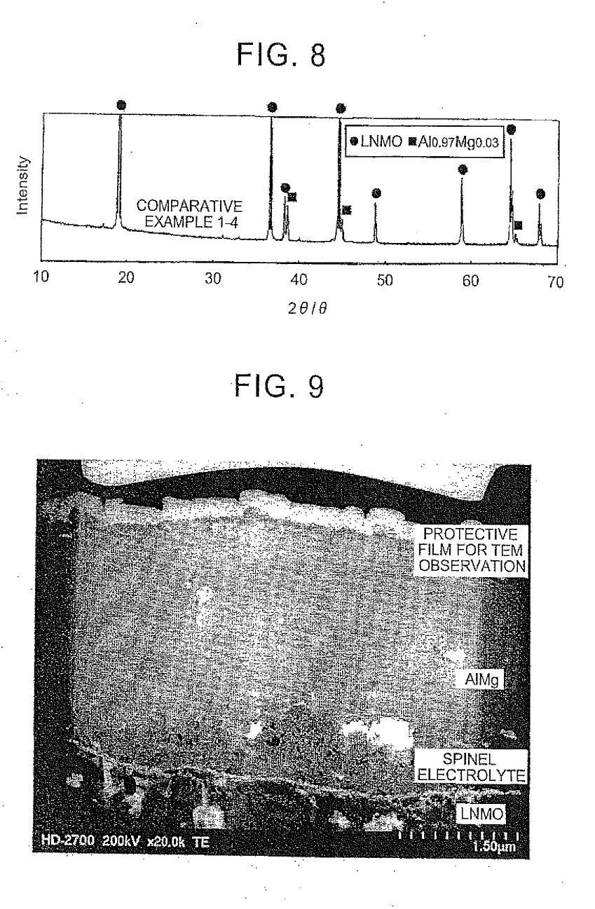

The mixed electrode layers obtained in Examples 1-1 and 1-2 and Comparative examples 1-1 to 1-4 were subjected to XRD measurement. The measurement was performed using CuKα rays, and conditions were set to 2θ=10° to 100°, 5°/min, step 0.02°. The results are depicted in FIG. 7A, FIG. 7B and FIG. 8. FIG. 7A illustrates results for the mixed electrode layers obtained in Examples 1-1 and 1-2 and Comparative examples 1-1 to 1-3. FIG. 7B is an enlarged diagram of FIG. 7A. In Examples 1-1 and 1-2 peaks of a spinel-structure oxide electrolyte (LiₓMg₁₋₂ₓAlₓ)Al₂O₄) having Li, Al and Mg were also observed, besides the peaks for LNMO and an AlMg alloy, as illustrated in FIG. 7A and FIG. 7B. Therefore, it was found that a solid electrolyte section was formed at the interface between the positive electrode active material and the negative electrode active material.

FIG. 8 illustrates XRD measurement results for the mixed electrode layer obtained in Comparative example 1-4. In Comparative example 1-4, the LNMO peak and the AlMg alloy peak were visible, but no electrolyte peak resulting from a reaction between LNMO and the AlMg alloy could be observed.

A cross-section of the mixed electrode layer obtained in Example 1-1 was observed using a TEM. Specifically, a thin specimen processed in accordance with a focused ion beam (FEB) method was observed by TEM. The results are depicted in FIG. 9. As FIG. 9 shows, a spinel-structure oxide electrolyte having Li, Al and Mg was formed, without any gaps, at the interface between LNMO and the AlMg alloy.

The LiNi_{0.5}Mn_{1.5}O₄ used in Example 1-1 was subjected to TG-DTA. The conditions were set to 25° C. to 1000° C. and 10° C./min. The results are depicted in FIG. 10. The results suggested that in a case where LiNi_{0.5}Mn_{1.5}O₄ is used, since LiNi_{0.5}Mn_{1.5}O₄ undergoes a reductive decomposition reaction at and above 600° C., as illustrated in FIG. 10, firing is preferably carried out in an oxygen-containing atmosphere (for instance, an air atmosphere) in order to suppress the reductive decomposition reaction.

### EXAMPLE 2-1

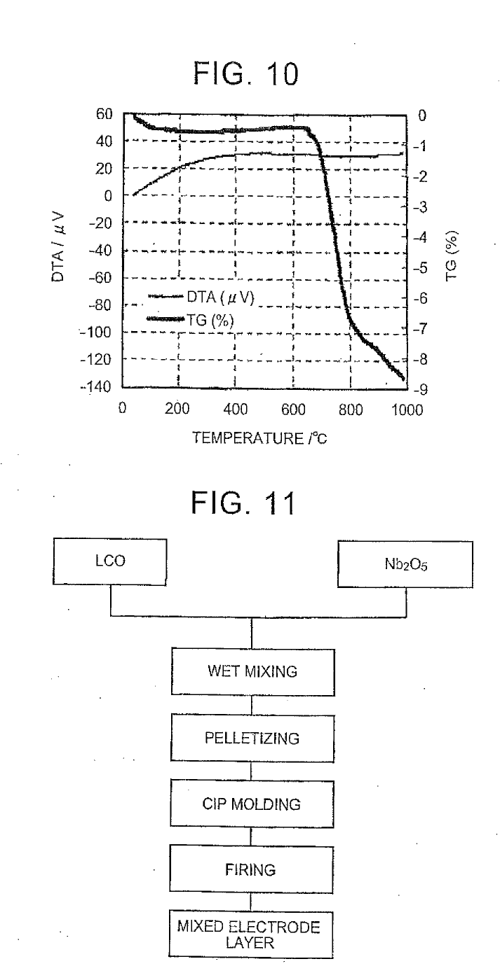

A mixed electrode layer in which a positive electrode active material and a negative electrode active material were present dispersed therein was produced in accordance with the flow illustrated in FIG. 11. Firstly, LiCoO₂ (LCO, by Nichia Corporation, positive electrode active material) and Nb₂O₅ (by Mitsui Mining and Smelting Company, Limited, negative electrode active material) were weighed to yield a weight ratio of positive electrode active material/negative electrode active material=1.47, and were wet-mixed in a dropping-type ball-mill. Ethanol was used as the solvent during mixing. The conditions in the ball mill were set to revolutions of 350 rpm and 6 hours. Next, the dried mixture was pressed in a die at 10 kN, to yield pellets. The pellets were pressed at 196 MPa using a CIP mold. The obtained molded body was heated under conditions of temperature rise rate of 3° C./min, in an air atmosphere. Upon reaching 500° C., the temperature was held there and firing was performed for 1 hour in that state. A mixed electrode layer was obtained as a result.

### EXAMPLES 2-2 TO 2-7, COMPARATIVE EXAMPLES 2-1 AND 2-2

Mixed electrode layers were obtained in the same way as in Example 2-1, but herein the firing temperature was modified as given in Table 2.

TABLE 2

| | Positive | | | |
|---|---|---|---|---|
| | electrode/ | | | |
| | negative | Positive | | |
| | electrode | electrode/negative | | Firing |
| | weight | electrode molar | Firing | temperature |
| | ratio | ratio | atmosphere | (° C.) |
| Comparative | 1.47 | 4.00 | Air | 300 |
| example 2-1 | | | | |
| Comparative | | | | 400 |
| example 2-2 | | | | |
| Example 2-1 | | | | 500 |
| Example 2-2 | | | | 600 |
| Example 2-3 | | | | 700 |
| Example 2-4 | | | | 800 |
| Example 2-5 | | | | 900 |
| Example 2-6 | | | | 1000 |
| Example 2-7 | | | | 1100 |

[Evaluation]

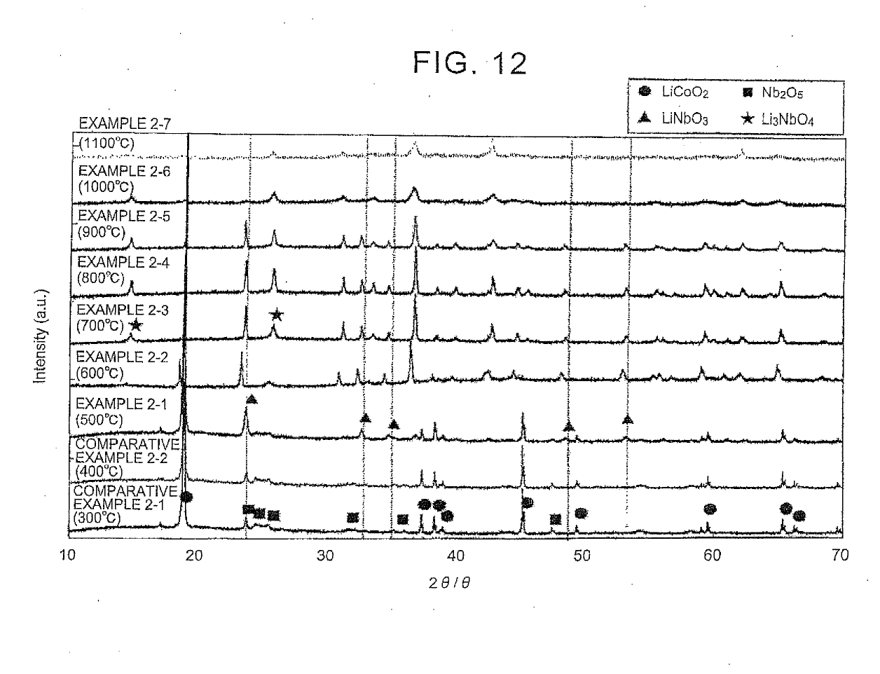

The mixed electrode layers obtained in Examples 2-1 to 2-7 and Comparative examples 2-1 and 2-2 were subjected to XRD measurement. The measurement was performed using CuKα rays, and conditions were set to 2θ=10° to 100°, 5°/min, step 0.02°. The results are depicted in FIG. 12. In Examples 2-1 and 2-2, formation of a LiNbO₃ electrolyte through reaction of LCO and Nb₂O₅ could be observed, but not formation of a Li₃NbO₄ electrolyte through reaction of LCO and Nb₂O₅, as illustrated in FIG. 12. Formation of a LiNbO₃ electrolyte and a Li₃NbO₄ electrolyte could be observed in Examples 2-3 to 2-5. In Examples 2-6 and 2-7, formation of a LiNbO₃ electrolyte could not be observed, but formation of the Li₃NbO₄ electrolyte could be observed. By contrast, no peaks of electrolytes resulting from reactions between LCO and Nb₂O₅ could be observed in Comparative example 2-1 or 2-2.

What is claimed is:

1. An all-solid-state battery containing a positive electrode active material and a negative electrode active material, comprising:
a mixed electrode layer in which the positive electrode active material and the negative electrode active material are present in a dispersed state, wherein
a solid electrolyte section that contains at least one element that makes up the positive electrode active material and at least one element that makes up the negative electrode active material is formed at an interface between the positive electrode active material and the negative electrode active material,
the solid electrolyte section is not formed at interfaces between the positive electrode active material portions and at interfaces between the negative electrode active material portions,
the positive electrode active material is a spinel-structure oxide that has Li, Ni and Mn, and
the negative electrode active material is an alloy that contains Al and Mg.

2. An all-solid-state battery containing a positive electrode active material and a negative electrode active material, comprising:
a mixed electrode layer in which the positive electrode active material and the negative electrode active material are present in a dispersed state, wherein
a solid electrolyte section that contains at least one element that makes up the positive electrode active material and at least one element that makes up the negative electrode active material is formed at an interface between the positive electrode active material and the negative electrode active material,
the solid electrolyte section is not formed at interfaces between the positive electrode active material portions and at interfaces between the negative electrode active material portions,
the positive electrode active material is a layered rock-salt oxide that has Li and Co, and the negative electrode active material is a Nb oxide.

3. A method for producing an all-solid-state battery, comprising the steps of:
preparing an electrode member in which a positive electrode active material and a negative electrode active material are in contact with each other; and
performing a thermal treatment on the electrode member and forming a solid electrolyte section that contains at least one element that makes up the positive electrode active material and at least one element that makes up the negative electrode active material, at an interface between the positive electrode active material and the negative electrode active material, wherein
the positive electrode active material is a spinel-structure oxide that has Li, Ni and Mn, and
the negative electrode active material is an alloy that contains Al and Mg.

4. The production method according to claim 3, wherein
the electrode member is a mixed electrode layer in which the positive electrode active material and the negative electrode active material are present in a dispersed state.

5. A method for producing an all-solid-state battery, comprising the steps of:
preparing an electrode member in which a positive electrode active material and a negative electrode active material are in contact with each other; and
performing a thermal treatment on the electrode member and forming a solid electrolyte section that contains at least one element that makes up the positive electrode active material and at least one element that makes up the negative electrode active material, at an interface between the positive electrode active material and the negative electrode active material, wherein
the positive electrode active material is a layered rock-salt oxide that has Li and Co; and the negative electrode active material is a Nb oxide.

6. The production method according to claim 5, wherein
the electrode member is a mixed electrode layer in which the positive electrode active material and the negative electrode active material are present in a dispersed state.
